(19) United States
(12) Patent Application Publication
(10) Pub. No.: US 2014/0334151 A1
(43) Pub. Date: Nov. 13, 2014

(54) LIGHTING DEVICE

(71) Applicant: DIEHL AEROSPACE GmbH, Ueberlingen (DE)

(72) Inventor: Karl-Heinz KIGELE, Zirndorf (DE)

(73) Assignee: DIEHL AEROSPACE GMBH, Ueberlingen (DE)

(21) Appl. No.: 14/272,812

(22) Filed: May 8, 2014

(30) Foreign Application Priority Data
May 10, 2013 (DE) 102013008067.3

(51) Int. Cl. F21K 99/00; F21V 29/00

(52) U.S. Cl. CPC F21K 9/30; F21V 29/246
USPC 362/249.02

(57) ABSTRACT

The invention relates to a lighting device, comprising a housing having a cover (1) which is at least sectionally transparent and a supporting plate (2) opposite the cover (1), on which supporting plate a printed circuit board (5) populated with a plurality of LEDs (6) on its upper side (O) is supported with its lower side (U), which is opposite the upper side (O), wherein a plurality of spring elements (7, 12) are fitted on the upper side (O) of the printed circuit board (5), which spring elements press against the cover (1) and force the lower side (U) of the printed circuit board (5) against the supporting plate (2).

### BACKGROUND OF THE INVENTION

The invention relates to a lighting device, in particular to the fitting of a printed circuit board populated with LEDs in the housing of such a lighting device.

### DISCUSSION OF THE PRIOR ART

In accordance with the prior art, lighting devices are generally known in which a printed circuit board is accommodated in a housing, with a plurality of LEDs being fitted on the upper side of said printed circuit board as light-emitting means. Generally, a transparent cover is provided on the housing on the opposite side to the upper side, through which cover the light generated by the LEDs is emitted to the surrounding environment.

During operation of such a lighting device, the LEDs produce a relatively large amount of heat, which needs to be dissipated in order to avoid overheating. For this purpose, it is known to attach heat sinks produced from aluminium, for example, to the printed circuit board or to dissipate the heat from the printed circuit board onto the housing by means of specific component parts, in particular spacers or the like. The provision of heat sinks or specific components requires complexity in terms of preparation and fitting.

### SUMMARY OF THE INVENTION

The object of the invention consists in eliminating the disadvantages of the prior art. In particular a lighting device comprising a printed circuit board populated with a plurality of LEDs which can be produced with reduced complexity and at the same time ensures the necessary heat dissipation from the printed circuit board is intended to be specified.

In accordance with the invention, a lighting device is proposed, said lighting device comprising a housing having a cover which is at least sectionally transparent and a supporting plate opposite the cover, on which supporting plate a printed circuit board populated with a plurality of LEDs on its upper side is supported with its lower side, which is opposite the upper side, wherein a plurality of spring elements are fitted on the upper side of the printed circuit board, which spring elements press against the cover and force the lower side of the printed circuit board against the supporting plate. —By virtue of the lower side of the printed circuit board being forced against the supporting plate, there is thermal contact between the printed circuit board and the supporting plate over a large area. As a result, the heat formed during operation of the lighting device by the LEDs can be passed quickly and efficiently from the printed circuit board onto the supporting plate and from there to the surrounding environment. According to the invention, the supporting plate of the housing is used for cooling the printed circuit board. It is possible to dispense with the provision of separate heat sinks. In addition, no specific component parts for connecting the printed circuit board to the housing are necessary, which at the same time enable dissipation of heat from the printed circuit board onto the housing. The proposed lighting device can moreover be produced and fitted easily.

The term “spring element” is understood to mean, for example, a helical spring, a metallic spring tongue or a similar element which permanently generates an elastic compressive force onto the printed circuit board.

Advantageously, the spring elements are fastened on the printed circuit board by means of a soldered joint. It is thus possible to integrate the spring elements in the population sequence for the printed circuit board. This enables quick and easy fitting of the spring elements on the upper side of the printed circuit board.

According to a further advantageous configuration, the spring elements are fitted along two mutually opposite edges of the printed circuit board. Generally, the printed circuit board is rectangular. The edges are expediently the long edges of the printed circuit board. By virtue of the spring elements being fitted along the edges, sufficient space remains between said edges for attaching a large number of LEDs. Moreover, by attaching the spring elements along the edges of the printed circuit board, undesirable shadowing is largely avoided.

In accordance with a further advantageous configuration of the invention, the lower side is provided with a heat distribution layer which is produced from a metal. In addition, a further heat distribution layer which is produced from a metal can be integrated in the printed circuit board. The metal is expediently copper or aluminium. For example, a layer produced from copper can be applied to the printed circuit board on the lower side. The provision of a heat distribution layer contributes to improved heat distribution and heat dissipation from the printed circuit board onto the supporting plate.

In accordance with a further configuration of the invention, the cover and the supporting plate are produced from a plastic profile, preferably extruded. The plastic profile can comprise two mutually opposite grooves for inserting the printed circuit board. In this case, the grooves are expediently arranged in such a way that the printed circuit board inserted therein rests on the supporting plate.

In accordance with a particularly advantageous configuration of the invention, in this case the spring elements are supported against limbs of the grooves, which limbs are opposite the supporting wall. As a result, the spring elements are barely visible from the outside, even when the plastic profile is produced in its entirety from a transparent plastic.

In accordance with an alternative configuration, the cover is produced from an extruded plastic profile. The supporting plate can in this case be part of a housing lower part which is produced from a further metal, preferably from aluminium. By virtue of the supporting plate being produced from a further metal, particularly efficient heat dissipation from the printed circuit board via the supporting plate to the surrounding environment is achieved.

In the alternative configuration of the invention, the cover, which is expediently produced from a transparent plastic, is latched with the housing lower part. For this, inwardly projecting latching hooks can be provided on an inner side of the cover, said latching hooks engaging in a corresponding latching web on the outer side of the housing lower part in the fitted state.

The cover and/or the supporting plate are expediently produced from polycarbonate.

### BRIEF DESCRIPTION OF THE DRAWINGS

Exemplary embodiments of the invention will be explained in more detail below with reference to the drawings, in which:

FIG. 1 shows a perspective view of a first lighting device,

FIG. 2 shows a sectional view according to FIG. 1,

FIG. 3 shows a perspective view of a second lighting device, and

FIG. 4 shows a sectional view according to FIG. 3.

### DETAILED DESCRIPTION OF THE DRAWINGS

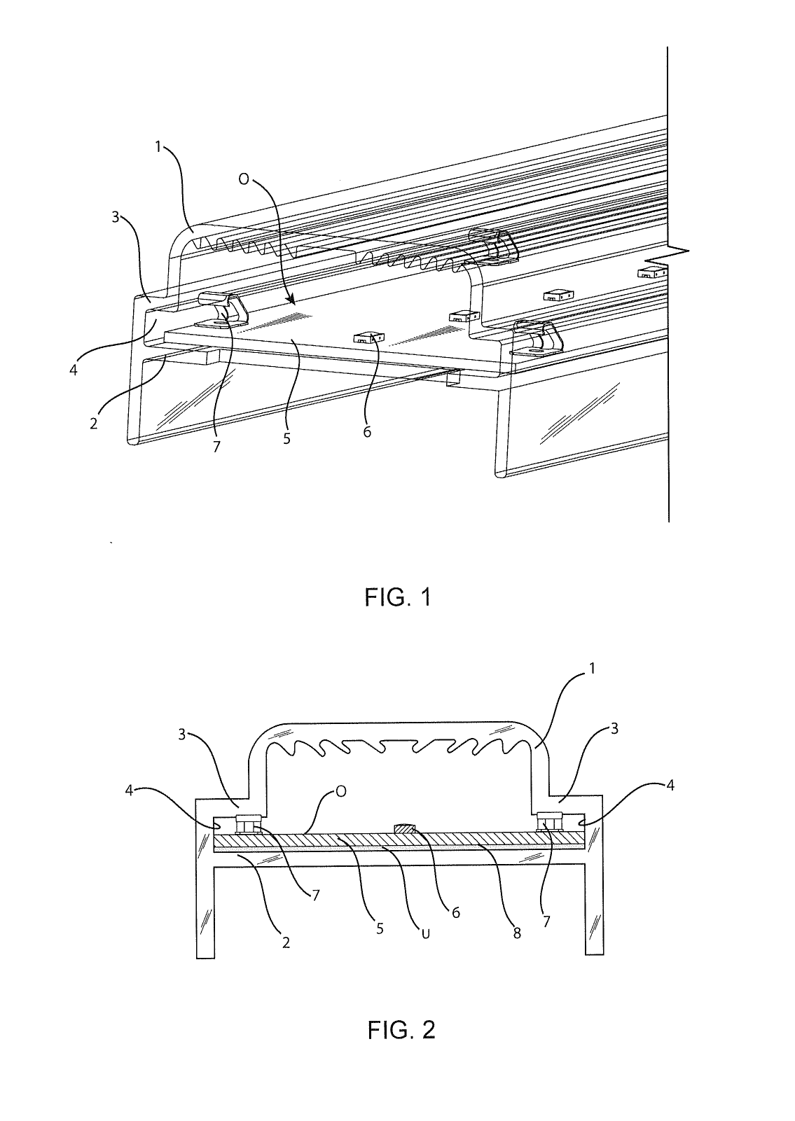

In the first lighting device shown in FIG. 1, a transparent cover 1 and a supporting plate 2 which is opposite the transparent cover 1 are produced integrally from a transparent plastic profile. A limb 3 of a groove 4 is formed by an inwardly projecting web between the cover 1 and the supporting plate 2, with a printed circuit board 5, which is supported on the supporting plate 2, engaging in said groove. LEDs 6 are fitted on an upper side O of the printed circuit board 5, said upper side facing the cover 1. Spring elements 7, which are supported against the limb 3 of the groove 4, are fitted on the upper side O along the long edges of the substantially rectangular printed circuit board 5. The spring elements 7 force the printed circuit board 5 against the supporting plate 2.

As can be seen in particular from FIG. 2, a metal layer 8 is provided on a lower side U of the printed circuit board 5, said lower side being opposite the upper side O, which metal layer can be formed from aluminium or copper, for example. The printed circuit board 5 is forced by the spring elements 7 so as to bear over the full area with the supporting plate 2. As a result, heat formed by the operation of the LEDs 6 can be dissipated over the full area over the metal layer 8 onto the supporting plate 2 and from there into the surrounding environment.

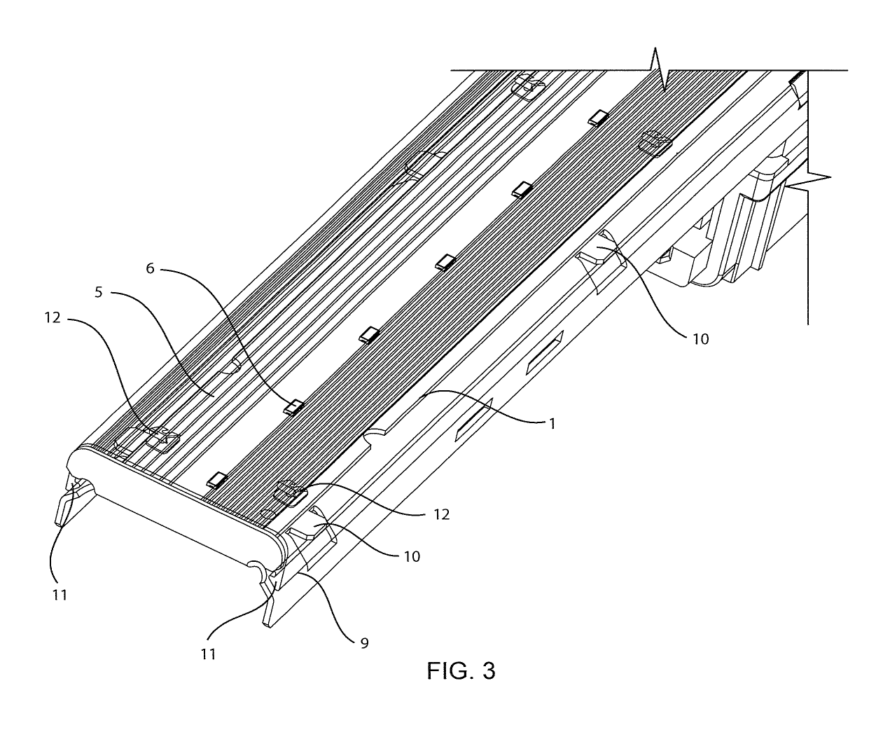

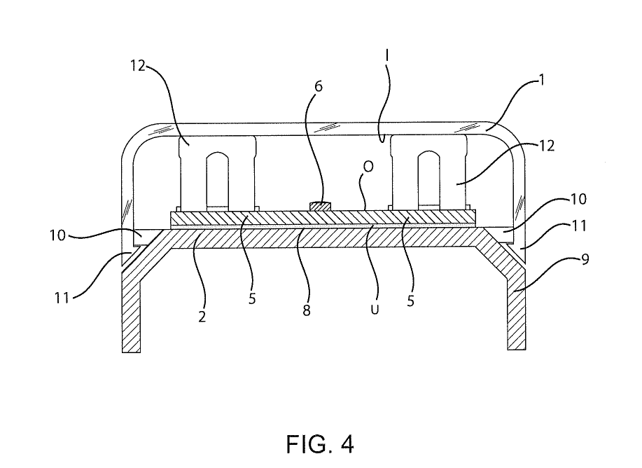

In the second lighting device shown in FIGS. 3 and 4, a housing is formed from a transparent cover 1 and a housing lower part 9 which is produced from metal, in particular aluminium. Latching tongues 10, with which the cover 1 is latched with hook-like protrusions 11 provided thereon, extend laterally from the housing lower part 9. The housing lower part 9 forms, in a similar manner to in the case of the first lighting device, the supporting plate 2, on which the printed circuit board 5 with the LEDs 6 fitted on the upper side O is supported.

In turn, a metal layer 8, produced from copper, for example, is provided on a lower side U of the printed circuit board 5. Further spring elements 12, which are supported against an inner side I of the cover 1 and force the printed circuit board 5 against the supporting plate 2, are fitted along the long edges of the printed circuit board 5 on the upper side O of said printed circuit board. Thus, in turn, efficient heat dissipation from the printed circuit board 5 onto the supporting plate 2 and from there into the surrounding environment is achieved.

The spring elements 7 and the further spring elements 12 are expediently fastened on the upper side O of the printed circuit board 5 by means of a soldered joint. As a result, they are therefore produced at least sectionally from metal. However, it may also be that the spring elements 7, 12 are in the form of plug-type elements and are plugged into a cutout in the printed circuit board 5. The spring elements 7, 12 can be produced from metal, plastic, synthetic foam, rubber or the like.

The transparent cover 1 is expediently produced from polycarbonate. It can be formed, for example, from an extruded plastic profile.

### LIST OF REFERENCE SYMBOLS

1 Cover
2 Supporting plate
3 Limb
4 Groove
5 Printed circuit board
6 LED
7 Spring element
8 Metal layer
9 Housing lower part
10 Latching tongue
11 Hook-like protrusion
12 Further spring element
I Inner side
O Upper side
U Lower side

What is claimed is:

1. A lighting device, comprising a housing having a cover which is at least sectionally transparent and a supporting plate opposite the cover, on which supporting plate a printed circuit board populated with a plurality of LEDs on its upper side (O) is supported with its lower side (U), which is opposite the upper side (O), wherein a plurality of spring elements are fitted on the upper side (O) of the printed circuit board, which spring elements press against the cover and force the lower side (U) of the printed circuit board against the supporting plate.

2. The lighting device according to claim 1, wherein the spring elements are fastened on the printed circuit board by means of a soldered joint.

3. The lighting device according to claim 1, wherein the spring elements are fitted along two mutually opposite edges of the printed circuit board.

4. The lighting device according to claim 1, wherein the lower side (U) is provided with a heat distribution layer which is produced from a metal.

5. The lighting device according to claim 1, wherein a further heat distribution layer which is produced from a metal is integrated in the printed circuit board.

6. The lighting device according to claim 5, wherein the metal is copper or aluminium.

7. The lighting device according to claim 1, wherein the cover and/or the supporting plate are produced from a plastic profile.

8. The lighting device according to claim 7, wherein the cover and/or the supporting plate are extruded from a plastic profile.

9. The lighting device according to claim 7, wherein the plastic profile comprises two mutually opposite grooves for inserting the printed circuit board.

10. The lighting device according to claim 9, wherein the spring elements are supported against limbs of the grooves, which limbs are opposite the supporting wall.

11. The lighting device according to claim 1, wherein the cover and/or the supporting plate is/are produced from polycarbonate.

12. The lighting device according to claim 1, wherein the supporting plate is part of a housing lower part which is produced from a further metal.

13. The lighting device according to claim 12, wherein said metal is aluminium.

14. The lighting device according to claim 12, wherein the cover is latched with the housing lower part.
